(19) United States
(12) Patent Application Publication
(10) Pub. No.: US 2014/0106800 A1
(43) Pub. Date: Apr. 17, 2014

(54) Information Processing Method and Mobile Terminal

(71) Applicant: Huawei Device Co., Ltd., Shenzhen (CN)

(72) Inventors: Shujuan Zhu, Shanghai (CN); Ying Li, Shanghai (CN)

(73) Assignee: Huawei Device Co., Ltd., Shenzhen (CN)

(21) Appl. No.: 14/132,357

(22) Filed: Dec. 18, 2013

Related U.S. Application Data
(63) Continuation of application No. PCT/CN2011/077806, filed on Jun. 29, 2011.

(51) Int. Cl. H04W 4/14

(52) U.S. Cl. CPC H04W 4/14
USPC 455/466

(57) ABSTRACT

The present invention discloses an information processing method and a mobile terminal. The method includes: obtaining a plurality of pieces of user data header information from a received short message; determining whether a long SMS identifier exists in the plurality of pieces of user data header information, where the long SMS identifier is used to identify the received short message as a long SMS; and if a determination result shows that a long SMS identifier exists in the plurality of pieces of user data header information, processing the received short message as a part of a long SMS; and if the determination result shows that no long SMS identifier exists in the plurality of pieces of user data header information, processing the received short message as a common short message. Adopting embodiments of the present invention can achieve correct processing of a long SMS with a plurality of message headers.

### CROSS-REFERENCE TO RELATED APPLICATION

This application is a continuation of International Application No. PCT/CN2011/077806, filed on Jul. 29, 2011, which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of mobile communications, and in particular, to an information processing method and a mobile terminal.

### BACKGROUND

With the development of mobile communications technologies, the requirements of users for mobile communications functions become increasingly higher, and users desire mobile terminals in various types of networks to be capable of supporting sending and receiving of a long short message service (SMS). The number of words in a long SMS is more than that in a common short message. For example, the number of words in a common short message is 70 or 75 while the number of words in a long SMS is 160 or 180. Of course, the specific number of words may vary.

A long SMS in an existing code division multiple access (CDMA) system and a long SMS in a global system for mobile communications (GSM) both use a user data header (UDH).

In an SMS, a user data segment may be formed by a message body and a message header (namely UDH). A UDH defined in GSM03.40 includes one or more information elements (IEs). One IE is formed by three fields: identifier, length, and data. The identifier has many types among which only concat8 or concat16 identifies a long SMS and other types have their own different meanings. For example, some indicate a short message content format and some indicate a Vcard short message.

At present, most CDMA long SMS have only one message header (which includes concat8 or concat16) without considering processing of a long SMS with a plurality of message headers. This may cause a problem that a received long SMS with a plurality of message headers that is sent by a GSM or universal mobile telecommunications system (UMTS) long SMS cannot be correctly displayed.

For example, in the prior art, when a terminal receives a long SMS, it considers by default that there is only one UDH. The terminal directly determines whether a first UDH includes concat8 or concat16. If yes, the UDH is stored as a segment of the long SMS. An attribute of the long SMS is recorded and matched with other segments that have been received. If not, the UDH is stored as a common short message.

When there are two UDHs in a received short message (for example, the first is a UDH of a format type, and the second is a message header that identifies a long SMS), the short message may not be considered as a segment of a long SMS, according to the prior art. As a result, such a short message cannot be received as a segment of a long SMS and cannot be displayed to a user.

### SUMMARY

Embodiments of the present invention provide an information processing method and a mobile terminal, which can implement correct processing of a long SMS with a plurality of message headers.

In one aspect, an embodiment of the present invention provides an information processing method, including: obtaining a plurality of pieces of UDH information from a received short message; determining whether a long SMS identifier exists in the plurality of pieces of user data header information, where the long SMS identifier is used to identify the received short message as a long SMS; and if a determination result shows that a long SMS identifier exists in the plurality of pieces of user data header information, processing the received short message as a part of a long SMS; and if the determination result shows that no long SMS identifier exists in the plurality of pieces of user data header information, processing the received short message as a common short message.

In another aspect, an embodiment of the present invention provides a mobile terminal, including: an obtaining module configured to obtain a plurality of pieces of user data header information from a received short message; a determining module configured to determine whether a long SMS identifier exists in the plurality of pieces of user data header information, where the long SMS identifier is used to identify the received short message as a long SMS; and a processing module configured to, if a determination result shows that a long SMS identifier exists in the plurality of pieces of user data header information, process the received short message as a part of a long SMS; and if the determination result shows that no long SMS identifier exists in the plurality of pieces of user data header information, processing the received short message as a common short message.

In the embodiments of the present invention, when it is determined whether a received short message is a long SMS, not only is it determined whether a long SMS identifier exists in a first piece of user data header information, but also it is determined whether a long SMS identifier exists in other pieces of user data header information. In this way, a problem of false determination of a long SMS with a plurality of message headers is avoided, and correct processing of a long SMS with a plurality of message headers can be achieved.

### BRIEF DESCRIPTION OF THE DRAWINGS

To illustrate the technical solutions in the embodiments of the present invention or in the prior art more clearly, the following briefly introduces the accompanying drawings required for describing the embodiments or the prior art. The accompanying drawings in the following description show merely some embodiments of the present invention, and a person of ordinary skill in the art may still derive other drawings from these accompanying drawings without creative efforts.

FIG. 1 is a specific schematic flowchart of an information processing method according to an embodiment of the present invention;

FIG. 2 is a specific schematic structural diagram of a mobile terminal according to an embodiment of the present invention; and

FIG. 3 is another specific schematic flowchart of an information processing method according to an embodiment of the present invention.

### DETAILED DESCRIPTION

In embodiments of the present invention, when receiving a short message, a terminal side considers by default that a short message may have a plurality of UDHs, and finally determines whether the short message is a long SMS after determining separately whether a long SMS identifier exists in these UDHs.

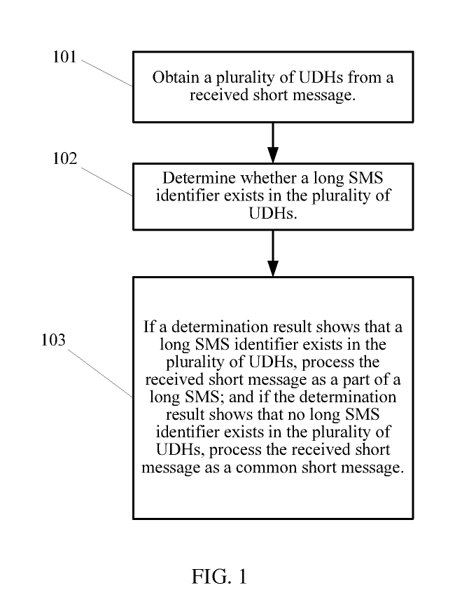

As shown in FIG. 1, an embodiment of the present invention provides an information processing method based on the idea described above, where the method includes the following steps:

101: Obtain a plurality of UDHs from a received short message. A network used for receiving and sending a short message may be a CDMA, GSM, wideband code division multiple access (WCDMA), or time division code division multiple access (TD-CDMA) network and so on.

102: Determine whether a long SMS identifier exists in the plurality of UDHs, where the long SMS identifier is used to identify the received short message as a long SMS.

For example, a sequential determination method may be used to determine one by one whether a long SMS identifier exists in all the UDHs in the received short message. Of course, other determination sequences and methods may also be used according to a system setting, and the details will not be described herein.

If an identifier field in an information element in a UDH is used to identify whether a short message is a long SMS, it is checked during determination whether the identifier field in the information element in one of the plurality of UDHs is a long SMS identifier. If the UDH is of another structure, it is checked in a corresponding field, according to a specific protocol definition, whether the short message is identified as a long SMS in the UDH. Meanwhile, the long SMS identifier may specifically be concat8 or concat16. For example, when content in the identifier field of one UDH in a short message is concat8 or concat16, the short message is determined as a long SMS.

103: If a determination result shows that a long SMS identifier exists in the plurality of UDHs, process the received short message as a part of a long SMS; and if the determination result shows that no long SMS identifier exists in the UDHs, process the received short message as a common short message.

For example, if a long SMS identifier exists in the plurality of UDHs, the short message is stored as a segment of a long SMS. An attribute of the long SMS is recorded and matched with other segments that have been received. If no long SMS identifier exists in the plurality of UDHs, the short message is stored as a common short message.

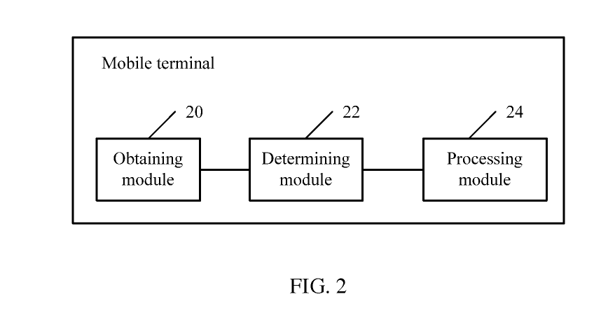

Corresponding to the preceding method, an embodiment of the present invention further provides a mobile terminal. As shown in FIG. 2, the mobile terminal includes: an obtaining module 20 configured to obtain a plurality of UDHs from a received short message; a determining module 22 configured to determine whether a long SMS identifier exists in the plurality of UDHs, where the long SMS identifier is used to identify the received short message as a long SMS; and a processing module 24 configured to, if a determination result shows that a long SMS identifier exists in the plurality of UDHs, process the received short message as a part of a long SMS; and if the determination result shows that no long SMS identifier exists in the plurality of UDHs, process the received short message as a common short message.

Similar to that in the preceding method, the determining module 22 may further be configured to determine sequentially whether a long SMS identifier exists in all the UDHs in the received short message, or determine whether an identifier field in an information element in the UDHs is a long SMS identifier.

The long SMS identifier includes concat8 or concat16.

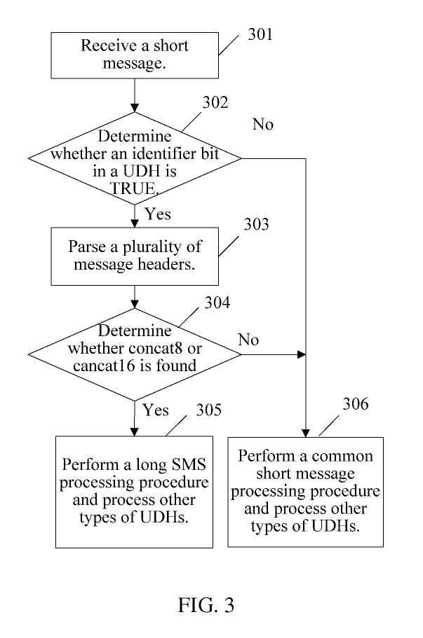

FIG. 3 is another specific schematic flowchart of an information processing method according to an embodiment of the present invention. The following describes each step in detail.

301: Receive a short message.

302: Check whether the message has an information header. For example, determine whether an identifier bit in a UDH is TRUE. If yes, go to step 303; otherwise, go to step 306.

303: Parse a plurality of UDHs in the received message.

304: Determine whether a UDH in the parsed UDHs includes concat8 or concat16. If a determination result shows that a UDH includes concat8 or concat16, go to step 305; otherwise, go to step 306.

305: Process the received message according to a processing method for a long SMS and accordingly process other UDHs obtained by parsing.

306: Process the received message according to a processing method for a common short message and accordingly process other UDHs obtained by parsing.

As can be seen from the preceding descriptions, in the embodiments of the present invention, when it is determined whether a received short message is a long SMS, not only a first UDH is determined, but also it is determined whether a long SMS identifier exists in other UDHs. In this way, a problem of false determination of a long SMS with a plurality of message headers is avoided, and correct processing of a long SMS with a plurality of message headers can be achieved.

Exemplary embodiments of the present invention are described above. It should be noted that various improvements and modifications may be further made by a person of ordinary skill in the art without departing from the principles of the present invention, and such improvements and modifications are also construed as falling within the protection scope of the present invention.

What is claimed is:

1. An information processing method, the method comprising:
obtaining a plurality of pieces of user data header information from a received short message;
determining whether a long short message service (SMS) identifier exists in the plurality of pieces of user data header information, wherein the long SMS identifier is used to identify the received short message as a long SMS;
when a determination result shows that a long SMS identifier exists in the plurality of pieces of user data header information, processing the received short message as a part of a long SMS; and
when the determination result shows that no long SMS identifier exists in the plurality of pieces of user data header information, processing the received short message as a common short message.

2. The information processing method according to claim 1, wherein determining whether the long SMS identifier exists in the plurality of pieces of user data header information comprises determining sequentially whether a long SMS identifier exists in all pieces of user data header information in the received short message.

3. The information processing method according to claim 1, wherein determining whether the long SMS identifier exists in the plurality of pieces of user data header information comprises determining whether an identifier field in an information element in the plurality of pieces of user data header information is a long SMS identifier.

4. The information processing method according to claim 1, wherein the long SMS identifier comprises concat8 or concat16.

5. The information processing method according to claim 1, where the method is used in a code division multiple access (CDMA) network or a global system for mobile communications (GSM) network.

6. A mobile terminal, comprising:
an obtaining module configured to obtain a plurality of pieces of user data header information from a received short message;
a determining module configured to determine whether a long short message service (SMS) identifier exists in the plurality of pieces of user data header information, wherein the long SMS identifier is used to identify the received short message as a long SMS; and
a processing module configured to:
when a determination result shows that a long SMS identifier exists in the plurality of pieces of user data header information, process the received short message as a part of a long SMS; and
when the determination result shows that no long SMS identifier exists in the plurality of pieces of user data header information, process the received short message as a common short message.

7. The mobile terminal according to claim 6, wherein the determining module is further configured to determine sequentially whether a long SMS identifier exists in all pieces of user data header information in the received short message.

8. The mobile terminal according to claim 6, wherein the determining module is further configured to determine whether an identifier field in an information element in the plurality of pieces of user data header information is a long SMS identifier.

9. The mobile terminal according to claim 6, wherein the long SMS identifier comprises concat8 or concat16.

10. The mobile terminal according to claim 6, wherein the mobile terminal is used in a code division multiple access (CDMA) or a global system for mobile communications (GSM) network.

11. A non-transitory computer-readable medium having computer usable instructions stored thereon for execution by a processor, wherein the instructions cause the processor to:
obtain a plurality of pieces of user data header information from a received short message;
determine whether a long short message service (SMS) identifier exists in the plurality of pieces of user data header information, wherein the long SMS identifier is used to identify the received short message as a long SMS;
when a determination result shows that a long SMS identifier exists in the plurality of pieces of user data header information, process the received short message as a part of a long SMS; and
when the determination result shows that no long SMS identifier exists in the plurality of pieces of user data header information, process the received short message as a common short message.

12. The non-transitory computer readable medium of claim 11, wherein the instructions cause the processor to determine whether the long SMS identifier exists in the plurality of pieces of user data header information by causing the processor to determine sequentially whether a long SMS identifier exists in all pieces of user data header information in the received short message.

13. The non-transitory computer readable medium of claim 11, wherein the instructions cause the processor to determine whether the long SMS identifier exists in the plurality of pieces of user data header information by causing the processor to determine whether an identifier field in an information element in the plurality of pieces of user data header information is a long SMS identifier.

14. The non-transitory computer readable medium of claim 11, wherein the long SMS identifier comprises concat8.

15. The non-transitory computer readable medium of claim 11, wherein the long SMS identifier comprises concat16.

16. The non-transitory computer readable medium of claim 11, wherein the instructions are used in a code division multiple access (CDMA) network.

17. The non-transitory computer readable medium of claim 11, wherein the instructions are used in a global system for mobile communications (GSM) network.
